(19) United States
(12) Patent Application Publication
(10) Pub. No.: US 2019/0063146 A1
(43) Pub. Date: Feb. 28, 2019

(54) MODULAR WINDOW ASSEMBLIES AND METHODS OF INSTALLATION AND MODIFICATION

(71) Applicant: Guardian Glass, LLC, Auburn HIlls, MI (US)

(72) Inventors: T. Brent FREESE, Auburn Hills, MI (US); Keith ALDRICH, Waterloo, IN (US); Duane O. RECKER, Auburn, IN (US); Robert A. VANDAL, Syracuse, IN (US); Shashi SHAH, Auburn Hills, MI (US)

(73) Assignee: Guardian Glass, LLC, Auburn Hills, MI (US)

(21) Appl. No.: 16/110,819

(22) Filed: Aug. 23, 2018

Related U.S. Application Data
(60) Provisional application No. 62/549,977, filed on Aug. 25, 2017.

(51) Int. Cl. E06B 7/28; E06B 3/66; E06B 3/26; E06B 3/67; E06B 3/28; E06B 3/263

(52) U.S. Cl. CPC E06B 7/28; E06B 3/6621; E06B 3/26; G09F 9/30; E06B 3/28; E06B 3/2632; E06B 3/6715

(57) ABSTRACT

A frame assembly for a modular window assembly for an opening in a structure comprises a main structural frame defining an electrical enclosure and being mountable to the structure, a removable exterior frame mountable to the main structural frame and defining an angled lip for water runoff, the removable exterior frame being configured to secure an outer glass pane of a set of glass panes of the modular window assembly, an insulating feature between the main structural frame and the removable exterior frame and configured to prevent thermal conduction therebetween, and at least one vapor neutralizer between the main structural frame and the removable exterior frame and configured to prevent moisture from accumulating within the modular window assembly. One primary benefit of this modular window assembly is the ability to swap out some or all of the set of glass panes and replace them with new glass technology as developed.

### CROSS-REFERENCE TO RELATED APPLICATIONS

This application claims the benefit of U.S. Provisional Application Number 62/549,977, filed on Aug. 25, 2017. The disclosure of this application is incorporated herein by reference in its entirety.

### FIELD

The present application relates to modular window assemblies for openings in structures and methods for installing and modifying the configuration of modular window assemblies.

### BACKGROUND

Commercial and residential buildings include facades. Oftentimes, those facades include windows in ribbon, punched, bounded, window wall, and/or other designs. Windows typically are designed to allow light into the building and present a pleasing or at least interesting architectural appearance for those on the building's exterior. Windows found on first floors in commercial settings oftentimes also allow passers-by to peer into stores, e.g., to “window shop,” be attracted by whatever goods or services are offered in retail or other space, etc.

Some facades include information and/or other displays. For example, it is not uncommon to see flat panel displays (e.g., liquid crystal displays, or LCDs) listing stores' hours, scrolling text or displaying an “attract loop” including images and/or video, etc. It also is increasingly common to see “switchable windows,” whose transparency can be changed “on demand” for privacy and/or other purposes. Such switchable windows oftentimes incorporate electrochromic, polymer-based (e.g., polymer-assembled or polymer-dispersed) liquid crystal, thermochromic, and/or other technologies. So-called “smart displays” that enable user interaction through touch, gesturing, and/or the like, also are becoming more and more common.

Although windows on building facades are basically ubiquitous, the incorporation of electronically-enabled features has been slow. One challenge relates to the comparatively high costs of such technologies. Moreover, once a proprietor chooses to incur the expenses associated with implementing one given technology, it oftentimes is not feasible cost-prohibitive to replace that technology, e.g., if it breaks, if a new tenant desires another technology (or no technology at all), if improvements in the technology become available, etc.

In addition to the potential cost outlays, there is the potential for disruption to the tenant, homeowner, or other party, e.g., caused by the construction required for technological changeover. Conventional window assemblies are very difficult to adjust or temporarily remove, such as for privacy reconfiguration or for cleaning. In addition, conventional window assemblies are incapable of receiving new glass technology as developed. Thus, while conventional window assemblies work for their intended purpose, there remains a need for improvement in the relevant art.

### SUMMARY

Certain example embodiments address these and/or other concerns. For example, certain example embodiments relate to customizable window assemblies that may be incorporated in building facades modularly, and/or associated methods. Such window assemblies may be customizable in the sense that they are designed in a manner that facilitates the easy replacement of the technological components that enable electronic and/or other functionality. Such techniques may be used in place of, or together with, more conventional window and/or display units.

In certain example embodiments, a window assembly is mountable to the façade of a building. At least first and second substantially parallel, spaced apart glass substrates are provided, with the first substrate being provided for orientation closer to an exterior of the building than the second substrate. A technology compartment is sized, shaped, and arranged to receive electronic components configured to provide functionality in connection with the window assembly. At least one frame is interposed between the first and second substrates. Fasteners are connected to the at least one frame, with the fasteners being manipulable between at least first and second positions, the first position securing the second substrate in the window assembly, the second position facilitating removal of the second substrate from the window assembly regardless of whether the window assembly has been mounted to the façade of the building and without also having to remove the first substrate from the window assembly.

In certain example embodiments, a window assembly arrangement, comprising a plurality of window assemblies according to the features disclosed herein, is provided.

Methods of making window assemblies and window assembly arrangements also are contemplated herein.

Methods of servicing window assemblies and window assembly arrangements also are contemplated herein. For example, a method of servicing a window assembly may include manipulating the fasteners to the second position; and removing the second substrate and any device it forms an integral part of from the window assembly while the fasteners are in the second position. Similarly, a method of servicing a window assembly in a window assembly arrangement may include manipulating the fasteners of the window assembly to be serviced to the second position; and removing the second substrate of the window assembly to be serviced and any device it forms an integral part of from the window assembly of the window assembly to be serviced while the fasteners of the window assembly to be serviced are in the second position.

The features, aspects, advantages, and example embodiments described herein may be combined to realize yet further embodiments.

According to another aspect of the present disclosure, a modular window assembly for an opening in a structure is presented. In one exemplary implementation, the modular window assembly comprises: a set of glass panes and a frame assembly mountable to the structure, the frame assembly comprising: a main structural frame being mountable to the structure, a removable exterior frame mountable to the main structural frame and defining an angled lip for water run-off, the removable exterior frame being configured to secure an outer glass pane of the set of glass panes, an insulating feature disposed between the main structural frame and the removable exterior frame and configured to prevent thermal conduction therebetween, and at least one vapor neutralizer between the main structural frame and the removable exterior frame and configured to prevent moisture from accumulating within the modular window assembly, wherein the frame assembly is operable to receive any glass technology as developed.

In some implementations, the frame assembly further comprises a carrier frame mountable to the main structural frame and configured to position and secure one or more inner glass panes of the set of glass panes. In some implementations, the carrier frame comprises one or more adjustable securing devices configured such that the one or more inner glass panes can be removed while the outer glass pane remains secured by the removable exterior frame.

In some implementations, the set of glass panes comprises the outer glass pane and two or more inner glass panes. In some implementations, the outer glass pane is a monolithic glass pane and the two or more inner glass panes are part of an insulated glass (IG) assembly. In some implementations, the IG assembly is a vacuum insulated glass (VIG) assembly and the modular window assembly further comprises an insulating cover over an interior portion of the frame assembly to improve the thermal performance of the frame assembly relative to the VIG assembly.

In some implementations, the at least one vapor neutralizer comprises (i) at least one dry seal disposed at an outer side of a cavity defined between the main structural frame and the removable exterior frame, (ii) at least one vapor barrier seal disposed at an inner side of the cavity, and (iii) at least one dust barrier seal disposed adjacent to or between the one or more inner panes.

In some implementations, the modular window assembly further comprises a trim component attachable to the frame assembly and configured to hide the frame assembly from view. In some implementations, the modular window assembly further comprises an electrical system having at least one of power wiring running through the electrical enclosure and to an external power source and communication wiring. In some implementations, the electrical system comprises at least one of a light system, a projection display system, a heating/ventilating/air conditioning (HVAC) system, an electrochromic system, and a dynamic shade system, a sensor system, an audio system, a noise cancellation system, wireless communication hubs, wireless communication repeaters, active collision avoidance systems, or other features as developed. In some implementations, security/protective features could be incorporated. Non-limiting examples of these features include blast mitigation, blackout, and electronic scrambling of all building-emitted signals (computers, phones, servers, etc.), which could effectively make the facility invisible through the window openings.

According to another aspect of the present disclosure, a frame assembly for a modular window assembly for an opening in a structure is presented. In one exemplary implementation, the frame assembly comprises: a main structural frame defining an electrical enclosure and being mountable to the structure, a removable exterior frame mountable to the main structural frame and defining an angled lip for water run-off, the removable exterior frame being configured to secure an outer glass pane of a set of glass panes of the modular window assembly, an insulating feature between the main structural frame and the removable exterior frame and configured to prevent thermal conduction therebetween, and at least one vapor neutralizer between the main structural frame and the removable exterior frame and configured to prevent moisture from accumulating within the modular window assembly, wherein the frame assembly is operable to receive any glass technology as developed.

In some implementations, the frame assembly further comprises a carrier frame mountable to the main structural frame and configured to position and secure one or more inner glass panes of the set of glass panes. In some implementations, the carrier frame comprises one or more adjustable securing devices configured such that the one or more inner glass panes can be removed while the outer glass pane remains secured by the removable exterior frame.

In some implementations, the set of glass panes comprises the outer glass pane and two or more inner glass panes. In some implementations, the outer glass pane is a monolithic glass pane and the two or more inner glass panes are part of an IG assembly. In some implementations, the IG assembly is a VIG assembly, and the frame assembly further comprises an insulating cover over an interior portion of the frame assembly to improve the thermal performance of the frame assembly relative to the VIG assembly. In some implementations, the frame could be composed of various materials and manufacturing methods to realize this thermal advantage and/or other requirements. This could include, for example only, pultruded and extruded frame constructions in multiple materials to accomplish specific requirements (insulation, signal mitigation, water intrusion, etc.).

In some implementations, the at least one vapor neutralizer comprises (i) at least one dry seal disposed at an outer side of a cavity defined between the main structural frame and the removable exterior frame, (ii) at least one vapor barrier seal disposed at an inner side of the cavity, and (iii) at least one dust barrier seal disposed adjacent to or between the one or more inner panes.

In some implementations, the modular window assembly comprises a trim component attachable to the frame assembly and configured to hide the frame assembly from view. In some implementations, the modular window system comprises an electrical system having at least one of power wiring running through the electrical enclosure and to an external power source and communication wiring. In some implementations, the electrical system comprises at least one of a light system, a projection display system, an HVAC system, an electrochromic system, and a dynamic shade system, a sensor system, an audio system, a noise cancellation system, wireless communication hubs, wireless communication repeaters, active collision avoidance systems, or other features as developed.

Further areas of applicability of the present disclosure will become apparent from the detailed description provided hereinafter. It should be understood that the detailed description and specific examples are intended for purposes of illustration only and are not intended to limit the scope of the disclosure to current technology or features as the modular window assemblies described herein are operable to receive any glass technology or electrical features as developed in the future.

### BRIEF DESCRIPTION OF THE DRAWINGS

The present disclosure will become more fully understood from the detailed description and the accompanying drawings, wherein:

FIG. 1 is a front perspective view of a first window assembly in accordance with certain example embodiments;

FIG. 2 is a rear perspective view of the first window assembly in accordance with certain example embodiments;

FIG. 3 is an exploded view of the first window assembly in accordance with certain example embodiments;

FIG. 4 is a collection of orthographic views of the first window assembly in accordance with certain example embodiments;

FIG. 5 is a front perspective view of a second window assembly in accordance with certain example embodiments;

FIG. 6 is a rear perspective view of the second window assembly in accordance with certain example embodiments;

FIG. 7 is an exploded view of the second window assembly in accordance with certain example embodiments;

FIG. 8 is a collection of orthographic views of the second window assembly in accordance with certain example embodiments;

FIG. 9 is a front perspective view of a third window assembly in accordance with certain example embodiments;

FIG. 10 is a rear perspective view of the third window assembly in accordance with certain example embodiments;

FIG. 11 is an exploded view of the third window assembly in accordance with certain example embodiments;

FIG. 12 is a collection of orthographic views of the third window assembly in accordance with certain example embodiments;

FIG. 13 is a rear perspective view of an assembly including three modular window assemblies connected to one another, in accordance with certain example embodiments;

FIG. 14 is a first rear perspective view showing an example of how an inner component can be removed from the FIG. 13 example assembly, in accordance with certain example embodiments;

FIG. 15 is a second rear perspective view showing an example of how an inner component can be removed from the FIG. 13 example assembly, in accordance with certain example embodiments;

FIG. 16 is an enlarged view of a lower portion of the FIG. 13 example assembly, in accordance with certain example embodiments;

FIG. 17 is an enlarged view of an upper portion of the FIG. 13 example assembly, in accordance with certain example embodiments;

FIG. 18 is a front perspective view of the FIG. 13 example assemble, in accordance with certain example embodiments;

FIG. 19 is an exploded view of a single modular window assembly that may be used in connection with the FIG. 13 example assembly, in accordance with certain example embodiments.

FIG. 20 is diagram of an example two-story structure having both load-bearing floor-to-ceiling window openings and other window openings according to some embodiments of the present disclosure;

FIG. 21 is a side view of an example modular window assembly including a frame assembly according to some implementations of the present disclosure;

FIG. 22A is a side view of the example modular window assembly of FIG. 21 including mounting hardware for installing the modular window assembly at a top of an opening;

FIG. 22B is a side view of the example modular window assembly of FIG. 21 including mounting hardware for installing the modular window assembly at a bottom of an opening;

FIG. 23 is a flow diagram of an example method of installing the example modular window assembly of FIG. 21 according to some implementations of the present disclosure; and

FIGS. 24A-24C illustrate various stages of the method of installing the example modular window assembly of FIG. 21 according to some implementations of the present disclosure.

### DETAILED DESCRIPTION

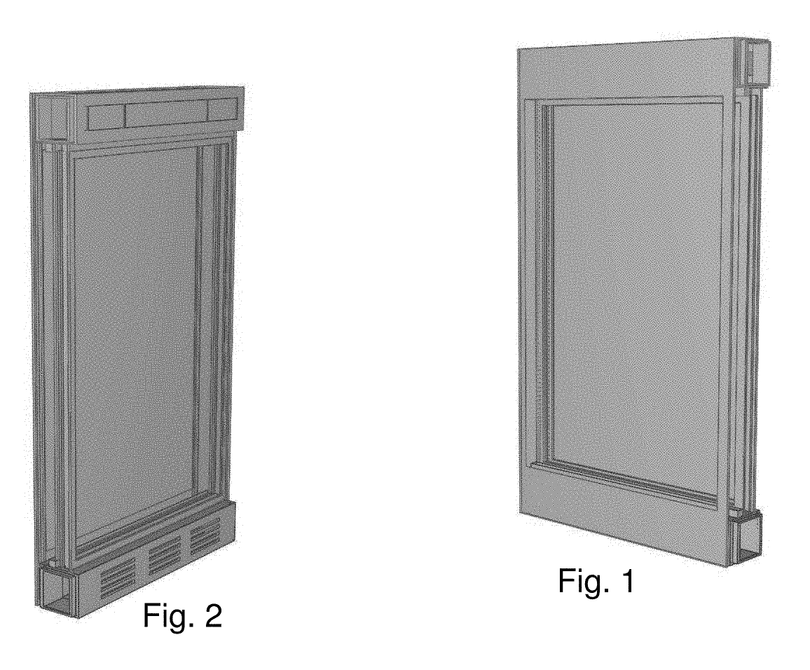

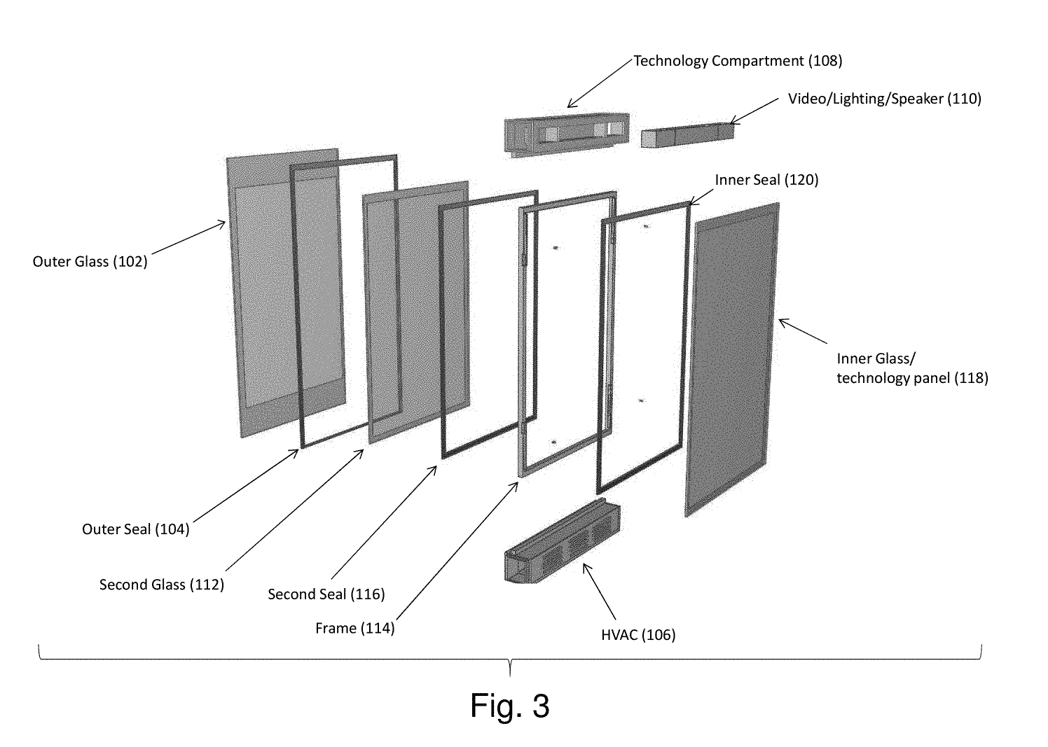

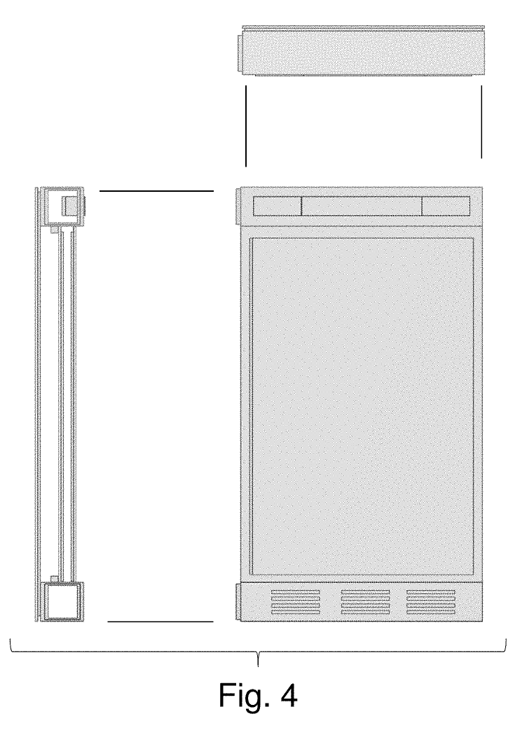

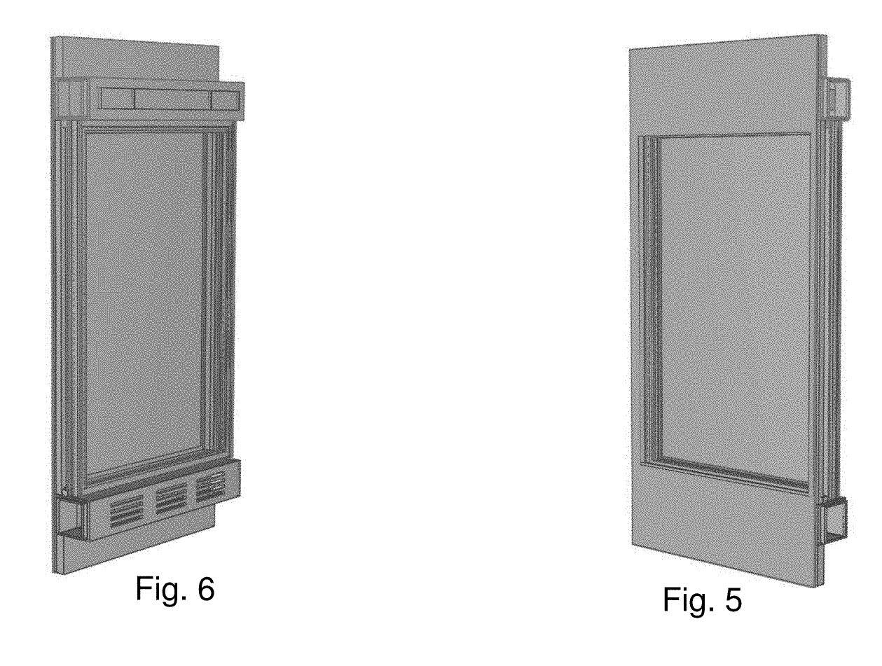

Certain example embodiments of this invention relate to window facades including window assemblies that are customizable to include electronic and/or other components and that can be assembled modularly. FIGS. 1-4 show a first window assembly in accordance with certain example embodiments. That is, FIG. 1 is a front perspective view of a first window assembly in accordance with certain example embodiments; FIG. 2 is a rear perspective view of the first window assembly in accordance with certain example embodiments; FIG. 3 is an exploded view of the first window assembly in accordance with certain example embodiments; and FIG. 4 is a collection of orthographic views of the first window assembly in accordance with certain example embodiments.

As shown in FIGS. 1-4, the outer glass substrate 102 is the outermost lite of the assembly. An outer seal 104 helps form a weather resistant seal around the outer glass substrate 102, connecting the with building façade, an HVAC unit 106, a technology compartment 108, and/or the like. The outer glass substrate 102 may be screen printed with a black frit or the like, e.g., at upper, lower, and/or side edges. A screen-printed or otherwise formed frame of this type may be used to conceal attachment means used to secure the finished assembly to the building façade, the HVAC unit 106 and/or technology compartment 108 that otherwise might be visible in whole or in part, etc. The outer seal 104 may be formed from any suitable material including, for example, foam, plastic, polyurethane, silicone, polyisobutyl, and/or the like. The outer glass substrate 102 may make the assembly appear as if it were an ordinary slab-to-slap or other window unit typical for a structure for the type in which it is located.

The HVAC unit 106 may heat and/or cool the complete assembly. For example, because the complete assembly may be located in cold climates or climates where the operating conditions vary, it may be desirable to provide for a more consistent range of operating temperatures for the entire assembly, e.g., proximate to the technology compartment 108. The HVAC unit 106 may also help keep the assembly cool, e.g., despite operation of the electronics in the technology compartment 108, the unit being placed in a hot climate, etc. Although an HVAC unit 106 is shown in FIG. 3 (for example), it will be appreciated that dedicated heaters, coolers, or the like may be used, e.g., in the event that the assembly is specifically manufactured for cool, hot, and/or other climates.

The technology compartment 108 may house technological and/or other components for the assembly. For instance, a modular component 110 may be provided to enable video, lighting, sound, and/or other functionality with respect to the assembly. Thus, the modular component 110 may include a projector, one or more LED and/or other light sources, a speaker, etc. Cameras and/or other proximity sensors, microphones, temperature gauges, and/or the like, alternatively or additionally may be provided. Control circuitry also may be located in the technology compartment 108, e.g., as provided with the modular component 110. For instance, a modular component 110 may include processing resources, including (for example) a hardware processor operably coupled to a memory storing instructions that, when executed by the processor, perform desired functionality. The desired functionality may include displaying an “attract loop” or other audiovisual production, showing store hours, scrolling news headlines, detecting proximity of a user and providing targeted advertisements, recording passers-by for surveillance and/or other purposes, etc.

The technology compartment 108 may have traces or other conduits, facilitating the connection of power to the assembly, and/or from assembly-to-assembly, e.g., when multiple assemblies are oriented close to one another in a modular or other fashion. The technology compartment 108 may also facilitate the provision of power and/or other electrical connection to technology components of the assembly. For instance, in touch panel configurations, leads may be provided to facilitate the reading out of signals from touch electrodes, components attached to the panel, etc. In electrochromic configurations, leads may be provided to facilitate provision of power needed for switching or the like. Power may be provided for active defogging and/or deicing, etc., e.g., by heating up a transparent conductive coating (TCC) or the like, etc. The technology panel or module additionally or alternatively may be self-powered and connection-free, e.g., by use of (for example) batteries, small solar cells with batteries and wireless interface, and/or the like. A dynamic shade (among other functional devices), for example, may work well with a small battery in some instances. In certain example embodiments, common or standardized low-power local or other wireless communication platform (e.g., a wireless ad-hoc network) may be implemented for providing control, user interface, and/or other features.

A second glass substrate 112 is provided interior to the outer glass substrate 102 and connected to a frame 114 via a second seal 116. The frame may include or have connected to it brackets, clips, fasteners, and/or the like for holding the technology compartment 108 and/or the HVAC unit 106. These elements additionally or alternatively may help secure the inner substrate and/or technology panel 118 in the assembly, and may help facilitate its removal and/or replacement, e.g., as described in greater detail below.

The frame 114 is connected to an inner glass substrate and/or technology panel 118 via an inner seal 120. The outer seal 104, second seal 116, and inner seal 120 may be formed from the same or different materials. It will be appreciated that these and/or other seals may be structural in certain example embodiments. It also will be appreciated that they may be provided to help maintain the substrates in substantially spaced apart relation to one another. Clamps and/or other mechanisms may be provided to help hold together some or all of the components, including some or all of the outer glass substrate 102, the second glass substrate 112, the frame 114, and the inner glass substrate and/or technology panel 118.

The frame 114 may be formed from any suitable material such as, for example, aluminum or other metal, plastic, and/or the like. In certain example embodiments, the frame 114 may form at least a part of a spacer system such that the second substrate 112 and the inner glass substrate and/or technology panel 118 function as an insulated glass unit. The same or similar may be true with respect to the outer seal 104 and the outer substrate 102 and the second substrate 112.

The inner glass substrate and/or technology panel 118 may be a modularized switchable (electrochromic, thermochromic, polymer-based, dynamic shade, or other technology) window, display device, touch panel, and/or the like. It may be interfaced with by a person interior to the building and/or exterior to the building. Capacitive and/or other touch technology may be used to detected touches, gestures, and/or the like. Cameras and/or other sensors housed in the technology compartment 108 or elsewhere may be used to facilitate control, as well. External control panels additionally or alternatively may interface with control circuitry for controlling a function of the inner glass substrate and/or technology panel 118 in certain example embodiments.

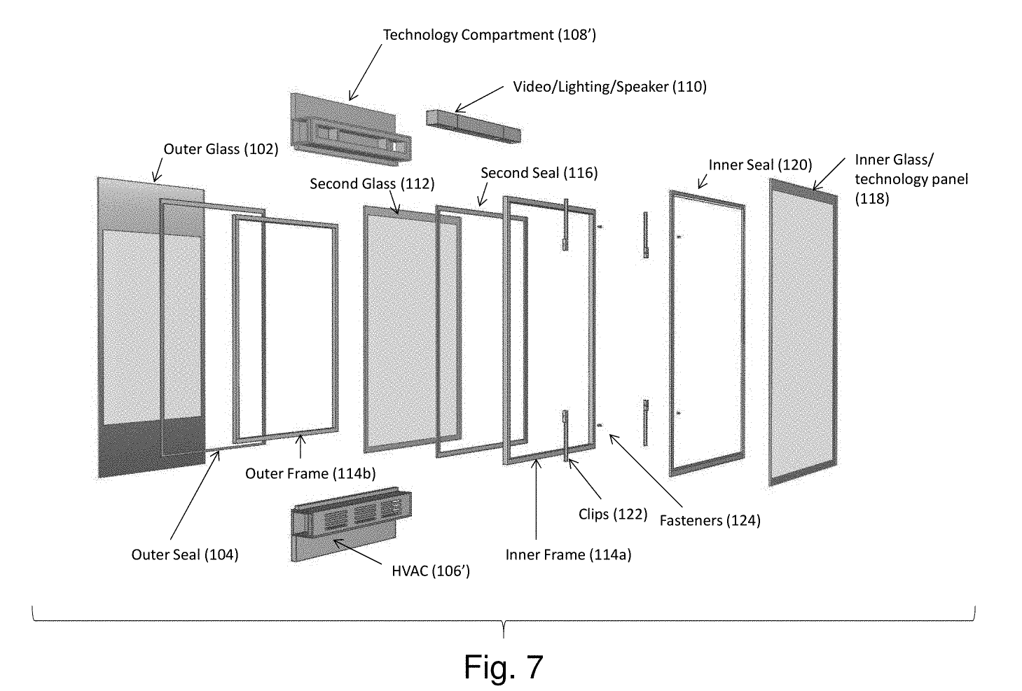

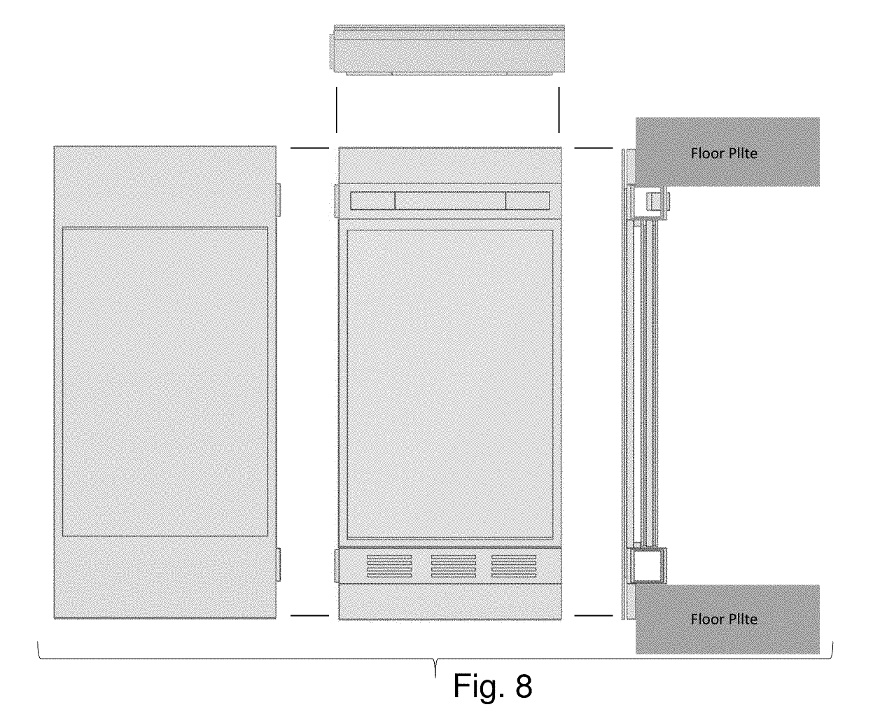

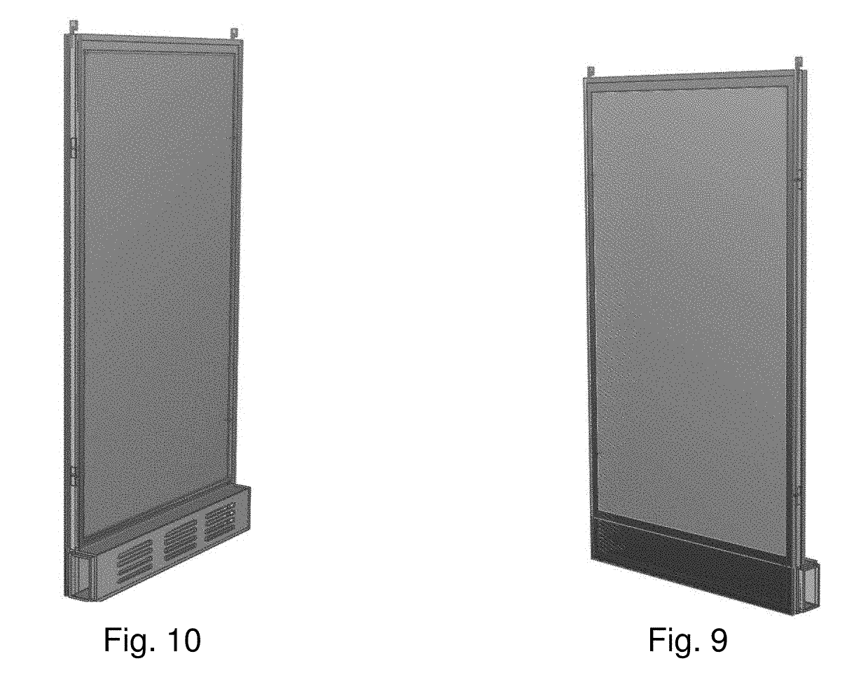

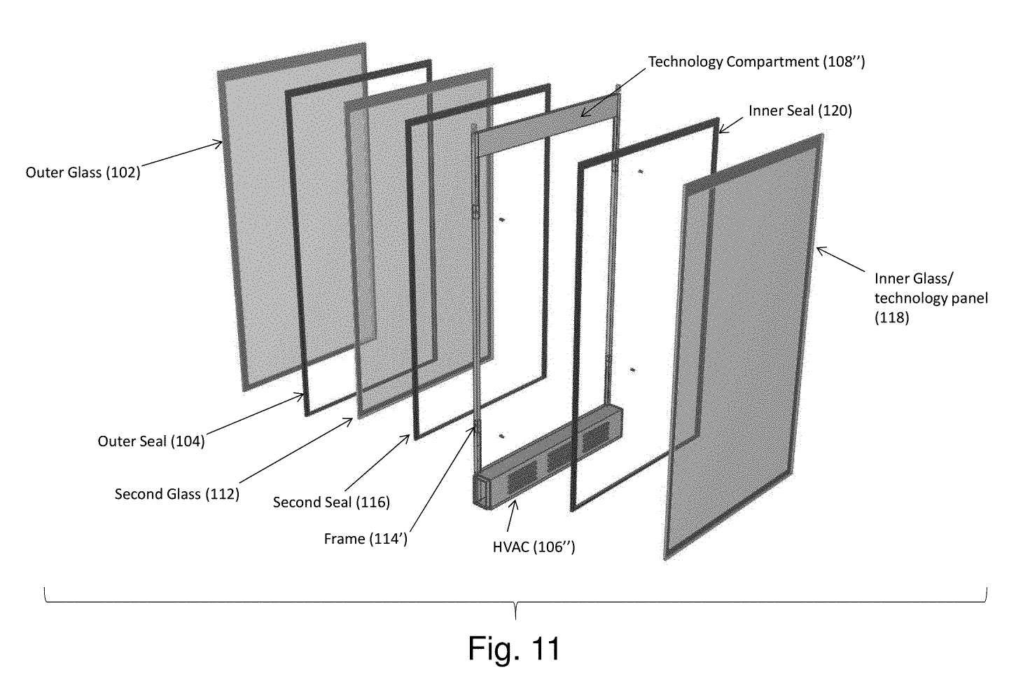

FIGS. 5-8 show a second window assembly in accordance with certain example embodiments. That is, FIG. 5 is a front perspective view of a second window assembly in accordance with certain example embodiments; FIG. 6 is a rear perspective view of the second window assembly in accordance with certain example embodiments; FIG. 7 is an exploded view of the second window assembly in accordance with certain example embodiments; and FIG. 8 is a collection of orthographic views of the second window assembly in accordance with certain example embodiments.

The second window assembly shown in connection with FIGS. 5-8 is similar to the first window assembly shown in and described in connection with FIGS. 1-4. In the second window assembly shown in connection with FIGS. 5-8, however, the HVAC unit 106′ and the technology compartment 108′ include more rigid backing members. These more rigid backing members may facilitate more robust and/or direct connections to the upper and/or lower slabs or floor plates of a building, e.g., as shown perhaps best in the far right of FIG. 8. These more rigid members may facilitate screwing, bolting, and/or other forms of securing as between the second window assembly and the outside of the building.

The second window assembly shown in connection with FIGS. 5-8 includes inner and outer frames 114a and 114b. As shown in FIG. 7, the inner frame 114a connects the second substrate 112 to the inner substrate and/or technology panel 118, e.g., in connection with the second seal 116 and the inner seal 120 provided on opposite sides of the inner frame 114a. The inner frame 114a shown in FIG. 7 thus is similar to the frame 114 shown in FIG. 3. The outer frame 114b, however, helps connect the outer substrate 102 to the second substrate 112, e.g., together with the outer seal 104 and an optional seal interposed between the outer frame 114b and the second substrate 112 (not shown). The inner and outer frames 114a and 114b may be formed from the same or different materials in different example embodiments. The inner and outer frames 114a and 114b may help in essence for a “triple” insulated glass unit, e.g., as between the outer substrate 102, the second substrate 112, and the inner substrate and/or technology panel 118. One or both of the HVAC unit 106′ and technology compartment 108′ may be mounted to the inner frame 114a and/or outer frame 114b, in different example embodiments.

FIG. 7 perhaps more clearly shows the clips 122 and fasteners 124, which may help connect the inner frame 114a to the HVAC unit 106′, the technology compartment 108′, and/or the and the inner substrate and/or technology panel 118.

It will be appreciated that the same or similar modifications, extensions, material selections, etc., as discussed above may be implemented in connection with this second assembly.

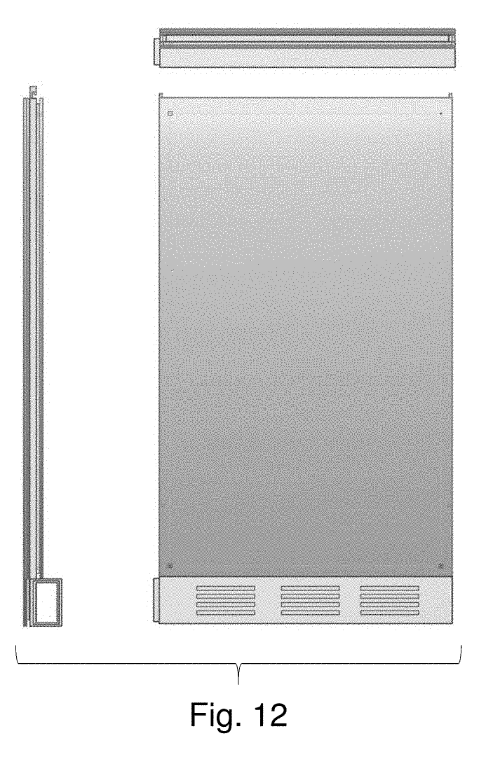

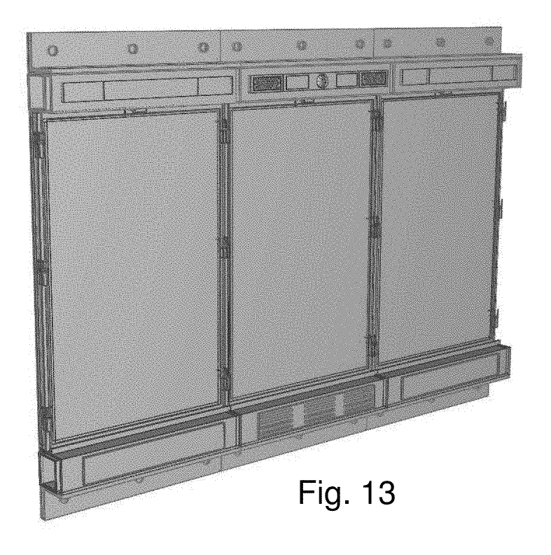

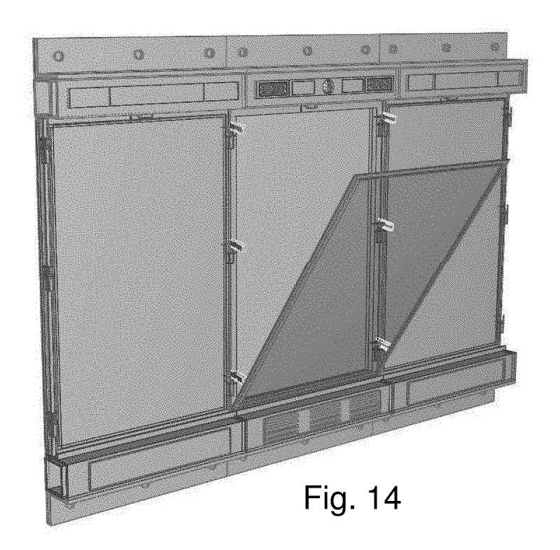

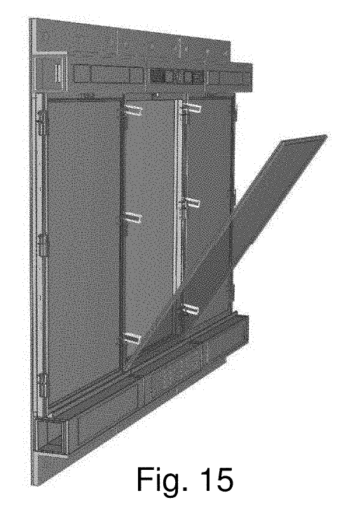

FIGS. 9-12 show a third window assembly in accordance with certain example embodiments. That is, FIG. 9 is a front perspective view of a third window assembly in accordance with certain example embodiments; FIG. 10 is a rear perspective view of the third window assembly in accordance with certain example embodiments; FIG. 11 is an exploded view of the third window assembly in accordance with certain example embodiments; and FIG. 12 is a collection of orthographic views of the third window assembly in accordance with certain example embodiments.

The third window assembly shown in connection with FIGS. 9-12 is similar to the first and second window assemblies shown in and described in connection with FIGS. 1-4 and FIGS. 5-8. For example, outer substrate 102, second substrate 112, and inner substrate and/or technology 118 are provided in substantially parallel spaced apart relation to one another. Outer seal 104, second seal 116, and inner seal 120 also are provided. It is noted, however, that the frame 114′ is shown to more directly support a somewhat slimmed down HVAC unit 106″ and a greatly slimmed down technology compartment 108″. The technology compartment 108″ may be completely replaced to change functionality of the third window assembly in certain example embodiments.

As shown in FIG. 11, for example, the outer substrate 102 does not include a large screen printed or otherwise concealing area. Instead, this example assembly may be provided where there are no or smaller floor plates or slabs, e.g., in residential areas, where it is possible to conceal connections, componentry, and/or the like, in other ways. Moreover, the frame 114′ is shown as having hooks, mounts, and/or other fastening members, which may assist with the mounting of the assembly in other ways, e.g., as compared to assembly-to-slab mounting techniques shown in connection with the two preceding example assemblies.

It will be appreciated that the same or similar modifications, extensions, material selections, etc., as discussed above may be implemented in connection with this second assembly.

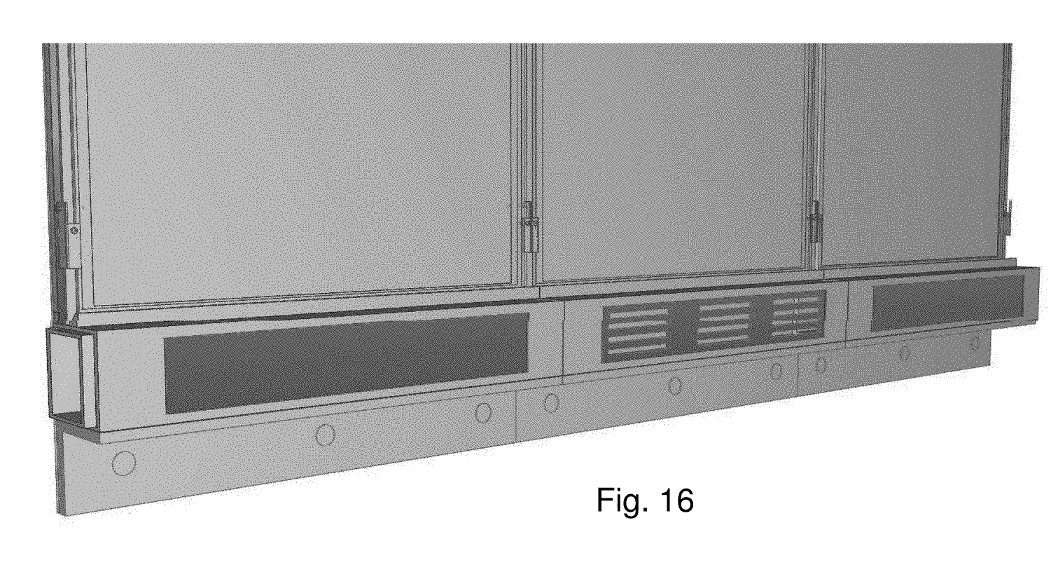

FIG. 13 is a rear perspective view of an assembly including three modular window assemblies connected to one another, in accordance with certain example embodiments. Although three modular window assemblies are shown in FIG. 13, different example embodiments may include more or fewer assemblies. Furthermore, although the FIG. 13 example shows windows connected together in a manner suitable for a ribbon-type arrangement, it will be appreciated that the assemblies disclosed herein may be used in connection with punched, window wall, and/or other designs.

In FIG. 13, the center assembly houses an HVAC unit suitable for heating and/or cooling the adjacent assemblies. To facilitate the flow of air between the assemblies, the ends of the frame proximate to where the unit is or could be are left open. However, to help prevent the escape of air from this path traversing the wall of the façade, baffles, slugs, plates, and/or the like, are used to close off openings for the outer two assemblies.

The technological components of the FIG. 13 example are all housed within the center assembly. Thus, similar to as with the HVAC unit, to facilitate the ease of electrical connections, the ends of the technology compartments are left open, e.g., so that wires can be strung across the various assemblies. To help protect the assembly from dust, debris, and/or the like, baffles, slugs, plates, and/or the like, are used to close off openings in the technology compartment for the outer two assemblies.

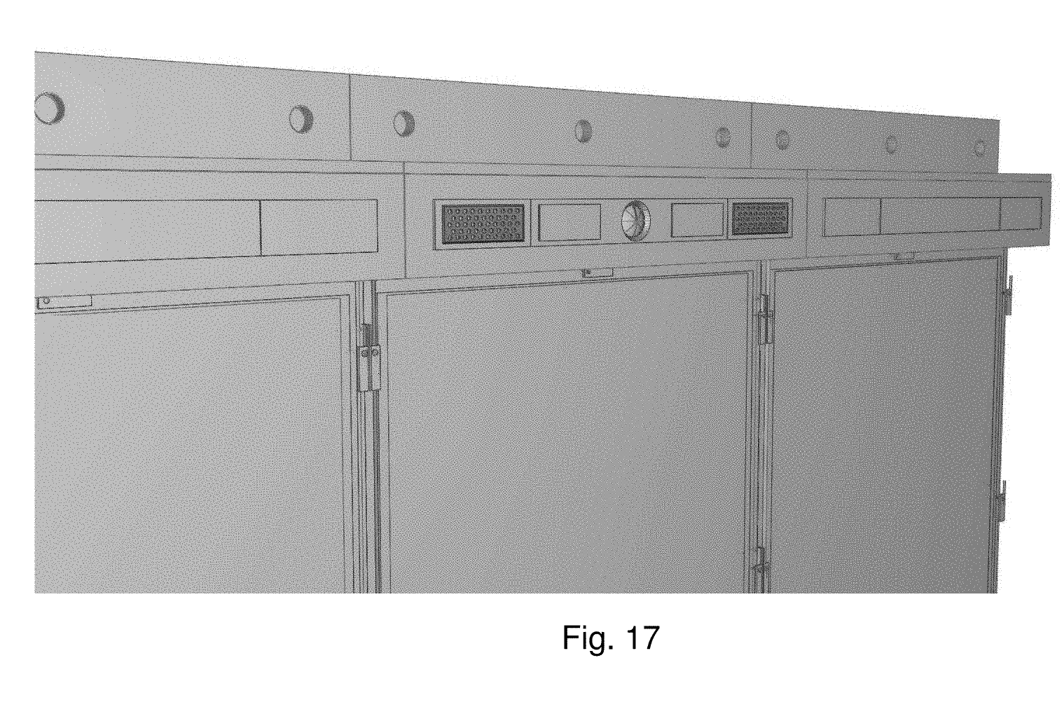

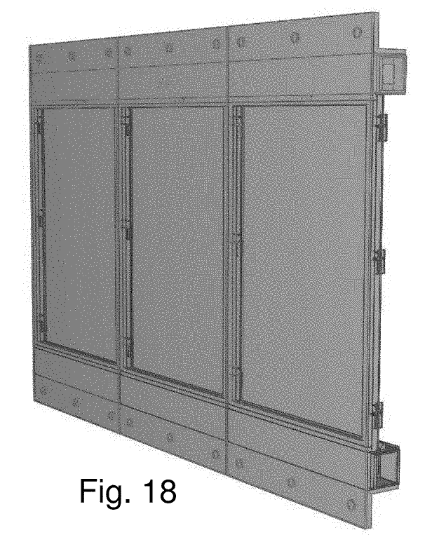

FIGS. 14-15 are first and second rear perspective views showing an example of how an inner component can be removed from the FIG. 13 example assembly, in accordance with certain example embodiments. That is, FIG. 13 shows the inner glass and/or technology panel securely attached to the assembly, using clips, fasteners, handles, and/or the like. FIGS. 14-15, however, show these handle-like clips being rotated to facilitate the release of the inner glass and/or technology panel from the center assembly. That panel can be carefully removed from the assembly and replaced with a new module, e.g., in the event of breakage, malfunction, upgrade to a new or different technology, replacement with a basic window, etc. Removal also may be desirable in the case of maintenance.

Advantageously, the technology disclosed herein facilitates servicing, replacement, etc., of the inner glass and/or technology panel from the inside of the building on a module-per-module basis. That is, it is not necessary to remove portions of the façade and/or adjust other assemblies when trying to work on a single assembly.

One or more connectors on an upper edge portion of the inner glass and/or technology panel may engage with one or more counterpart connectors provided via the technology compartment, e.g., to facilitate powering, data exchange, control signals, feedback, and/or the like.

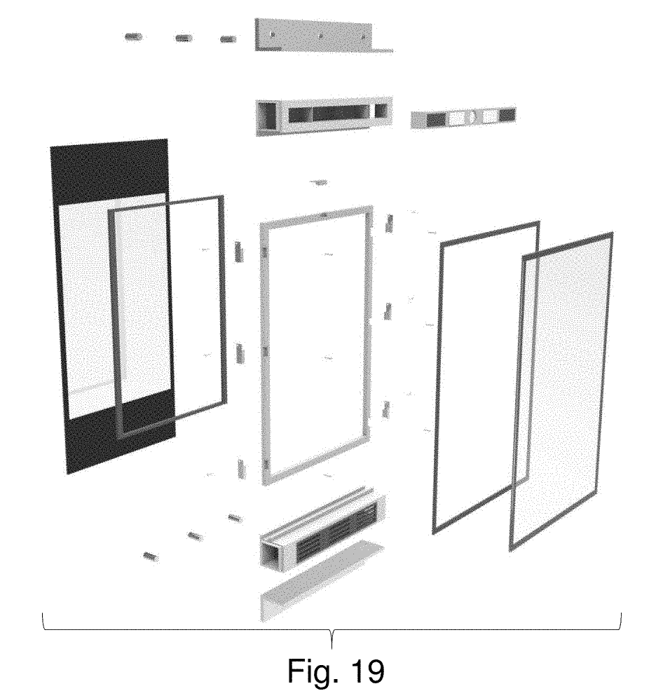

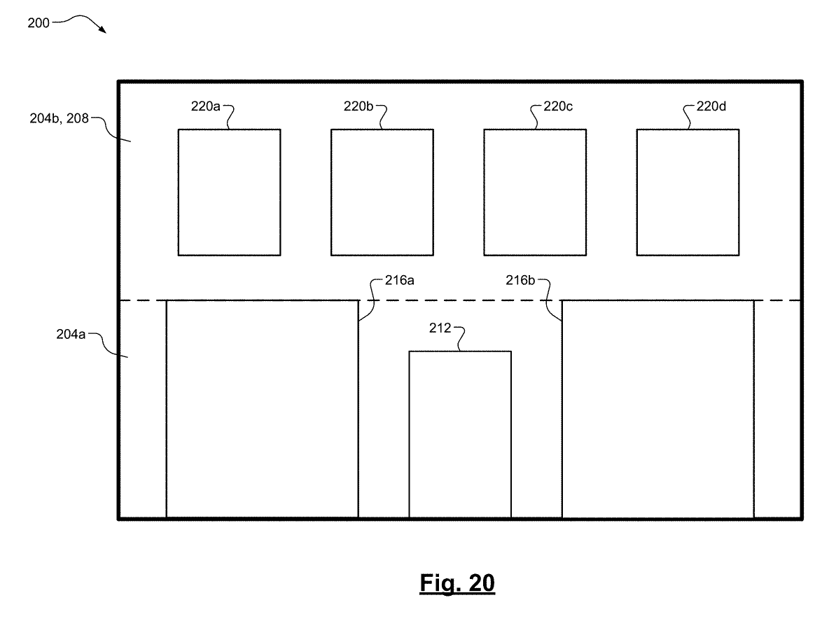

FIG. 16 is an enlarged view of a lower portion of the FIG. 13 example assembly, in accordance with certain example embodiments; and FIG. 17 is an enlarged view of an upper portion of the FIG. 13 example assembly, in accordance with certain example embodiments. FIG. 16 shows more detail concerning the HVAC unit and the associated baffles, and enlarged detail regarding the clips. FIG. 17 shows more details concerning the technology compartments and the associated baffles. FIG. 17 also shows that the technology compartment in the center assembly of the FIG. 13 example houses a center light and two speakers. Control circuitry also is included therein.

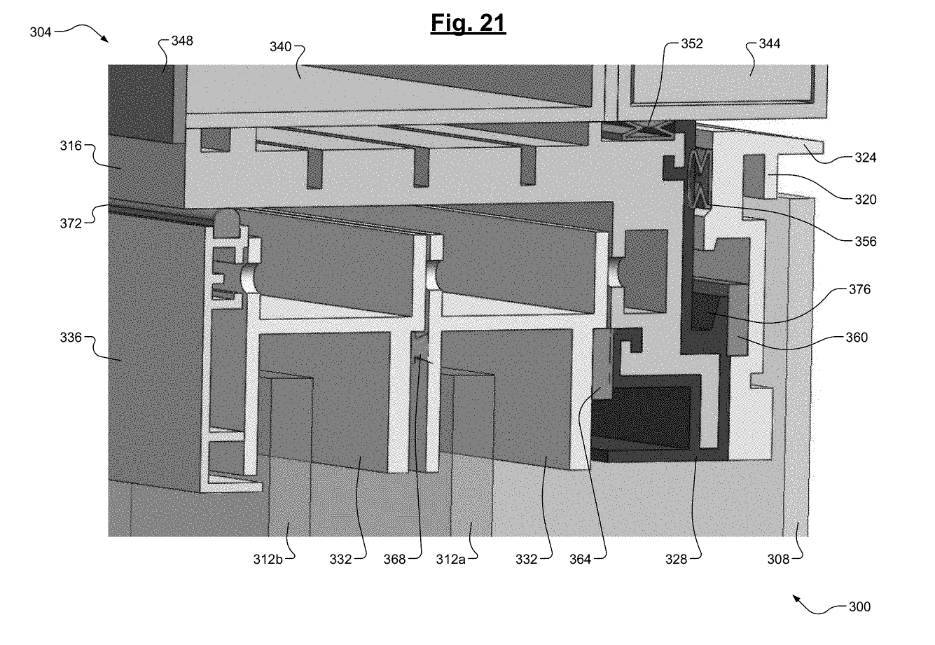

FIG. 18 is a front perspective view of the FIG. 13 example assemble, in accordance with certain example embodiments. Features enabling the group of assemblies to be attached to the building façade are shown. These features may include pre-drilled in the backing places attached to the technology compartments and/or HVAC unit holders.

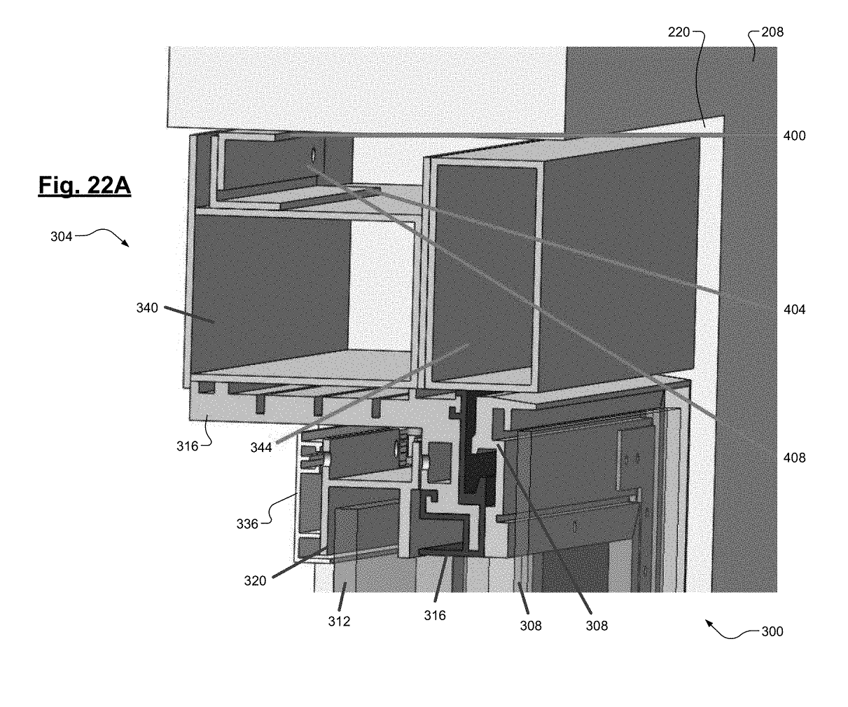

FIG. 19 is an exploded view of a single modular window assembly that may be used in connection with the FIG. 13 example assembly, in accordance with certain example embodiments. FIG. 19 is a more rendered view, showing components of a single assembly provided in the FIG. 13 example and similar to the second example assembly shown in and described in connection with FIGS. 6-8.

Methods of making, configuring, repairing, individual assemblies, groupings of assemblies, building facades, etc., are contemplated herein.

Although certain example embodiments are described as including glass substrates, it will be appreciated that other substrates may be used for one or more of the transparent panels therein. Additionally, although certain example embodiments are described in connection with having a functional panel on the interior of the building, it will be appreciated that the functional panels may be provided outside of the building.

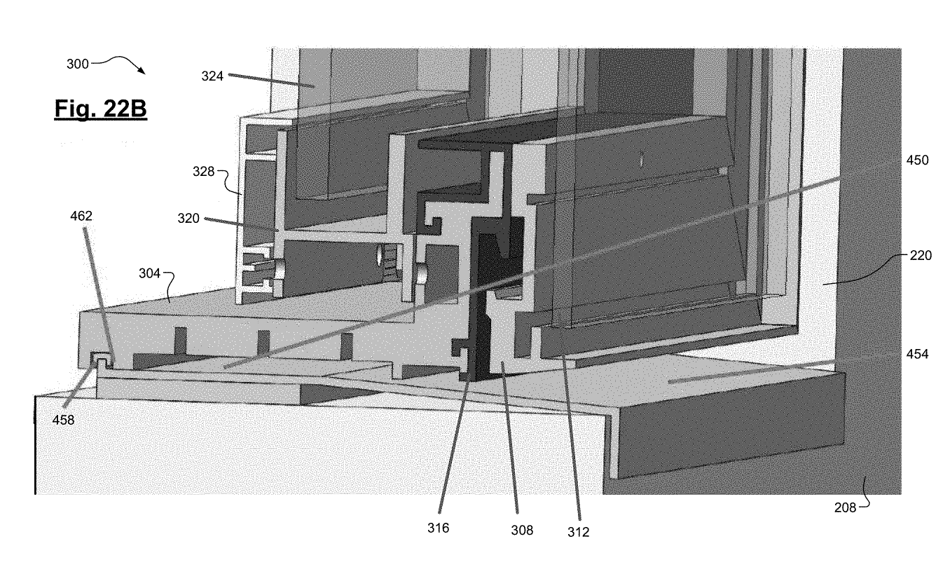

Referring now to FIG. 20, an example structure 200 having two different levels 204a, 204b is illustrated. A lower portion of a front surface or façade 208 of the structure 200 defines a door opening 212 and two floor-to-ceiling window openings 216a and 216b (“openings 216”). Floor-to-ceiling window assemblies can be installed in these openings 216. Such window assemblies, however, have to be designed for load-bearing and thus can be relatively complex and expensive. An upper portion of the front surface 208 of the structure 200 defines four openings 220a, 220b, 220c, and 220d (“openings 220”). Window assemblies, such as the modular window assemblies illustrated and described herein, can be installed in these openings 220. Such window assemblies do not have to be load-bearing because the structure 200 has load-bearing framing around an outside of the openings 220. This allows for greater design flexibility and reduced costs for window assemblies. Non-limiting examples of the openings include punched hole openings and bounded openings, but it will be appreciated that the modular window assemblies described herein are applicable to any opening in a structure.

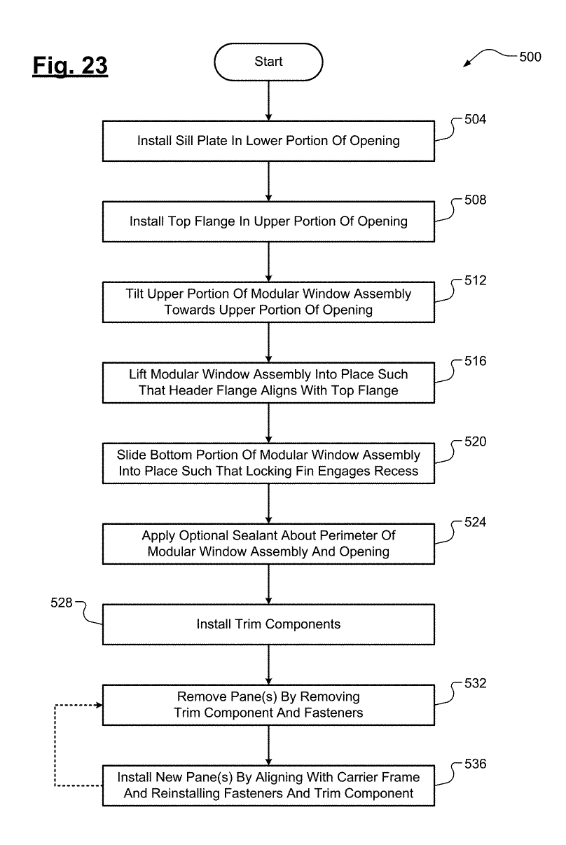

Referring now to FIG. 21, a side view of an example modular window assembly 300 is illustrated. The modular window assembly 300 includes a frame assembly 304 that secure at least one glass pane 308, 312. As illustrated, the frame assembly 304 secures both a single outer glass pane 308 and two inner glass panes 312a, 312b (“inner glass panes 312”). In one exemplary implementation, the outer glass pane 308 is a monolithic glass pane. While not shown, it will be appreciated that some or all of the glass panes 308, 312 could have coatings applied thereto. In one exemplary implementation, two or more of the inner glass panes 312 collectively for an insulated glass (IG) unit. In one exemplary implementation, the IG unit is a vacuum insulated glass (VIG) unit. It will also be appreciated that only a single inner glass pane 308 or other types of inserts could be implemented. For example only, a laminate glass pane for blast resistance could be implemented. One primary benefit of the modular window assembly 300 is the operability to receive any glass technology as developed. That is, any suitable configuration of one or more glass panes could be installed and glass pane(s) can also be swapped out over time for new pane(s) or to incorporate new glass technology. This could include, for example only, new types of glass pane(s) or new types of IG units as developed, or glass pane(s) having new coatings as developed.

For very high thermal performance inserts, such as a VIG unit, the frame assembly 304 could include additional insulating componentry in order to capitalize on the thermal performance benefits. Non-limiting examples of this additional componentry include a thin metal or plastic insulating cover over an interior portion of the frame. In some implementations, this thin insulating cover could further comprise a thin layer of insulating material, such as vacuum panels, foam, or aerogel. It will be appreciated that other suitable insulating materials could be utilized or other suitable componentry could be added to the frame assembly 304 in an effort to realize the maximum thermal performance benefit of the insert(s).

The frame assembly 304 comprises a main structural frame 316 and a removable exterior frame 320. The removable exterior frame 320 secures the outer pane 308 and also defines an angled lip 324 (e.g., a 5 degree angle) for water run-off. An insulating feature 328 is disposed between the main structural frame 316 and the removable exterior frame 320. Non-limiting examples of the insulating feature include a thermal break, an air cavity, a vacuum cavity, and other materials and/or gases as developed. The main structural frame 316 receives one or more carrier frames 332, each of which secures one or more of the inner panes 312. A trim component or panel 336 attaches to an inner most carrier frame 332 to hide all or a majority of the frame assembly 304 from view from an inside the structure 200. As described above, this trim component 336 or an additional trim component (not shown) could be insulating to capitalize on the thermal performance benefits of particular inserts (e.g., VIG).

The frame assembly 304 optionally includes an electrical enclosure 340 atop the main structural frame 316 and an insulation enclosure 344 disposed in front of the electrical enclosure 340. A back plate or trim component 348 hides and allows for access to the electrical enclosure 340. The electrical enclosure 340 can house electrical components and/or wiring for the modular window assembly 300, such as power wiring connecting one or more electrical devices to an external power source (e.g., an electrical system of the structure 200) and/or communication wiring (low voltage communication wiring, fiber optic communication wiring, etc.). It will be appreciated that the terms “electrical system” and “electrical device” as used herein can include both electrical power and communication componentry. Non-limiting examples of these electrical devices include a light system, a projection display system, a heating/ventilating/air conditioning (HVAC) system, an electrochromic system, and a dynamic shade system, one or more sensors, one or more audio devices (microphones, speakers, etc.), a noise cancellation system (e.g., active noise cancellation), wireless communication hubs and repeaters, active collision avoidance systems, and other features or technology as developed. The insulation enclosure 344 can house thermal insulation, but it will also be appreciated that the insulation enclosure 344 could house a portion of the electrical system described above, such as a light system for accenting the modular window assembly 300 as viewed from outside.

The frame assembly 304 further comprises at least one vapor neutralizer. Non-limiting examples of the vapor neutralizer(s) include seals and desiccants. Seals act to prevent moisture from entering a space, whereas desiccants act to absorb moisture from a space. As shown, seals 352 and 356 are primary barrier seals that primarily prevent water (as well as airflow and/or sound) from entering an interior of the modular window assembly 300. Non-limiting examples of these seals 352 include butterfly and bulb-type seals, such as a silicone bulb, a silicone foam, an ethylene propylene diene monomer (EPDM) rubber bulb, and an EPDM rubber foam. Seals 360 and 364 are anti-vapor seals that primarily prevent moisture from entering an interior of the modular window assembly 300. In one exemplary implementation, seal 364 includes a unique foil moisture barrier. These seals 360 and 364 could optionally have a desiccant associated therewith, but it will be appreciated that an optional desiccant could be disposed elsewhere.

Lastly, seals 368 and 372 are breathable anti-dust seals that primarily prevent dust from entering between the inner glass panes 312. Non-limiting examples of these seals 368 and 372 include pile and felt strips. The insulating feature 328 is acts as a thermal barrier to prevent the transfer of heat from the removable exterior frame 320 to the main structural frame 316 and vice-versa. The insulating feature 328 and the removable exterior frame 320 also collectively form a water run-off channel 376. Any water that is able to pass seal 356 could be expelled from the modular window assembly 300 via this channel 376. The insulating feature 328 could be, for example, a slip-in polymer (e.g., polyamide) component that forms the above-described conduction barrier. In one exemplary implementation, the insulating feature 328 is formed of a dense material (e.g., 80-90 durometer) for withstanding fastener pass-through and accommodating high temperature and moisture ranges. It will be appreciated that the seals and/or desiccants described herein are merely examples of water management systems and it will be appreciated that any suitable water management system could be utilized to prevent moisture from accumulating within the modular window assemblies.

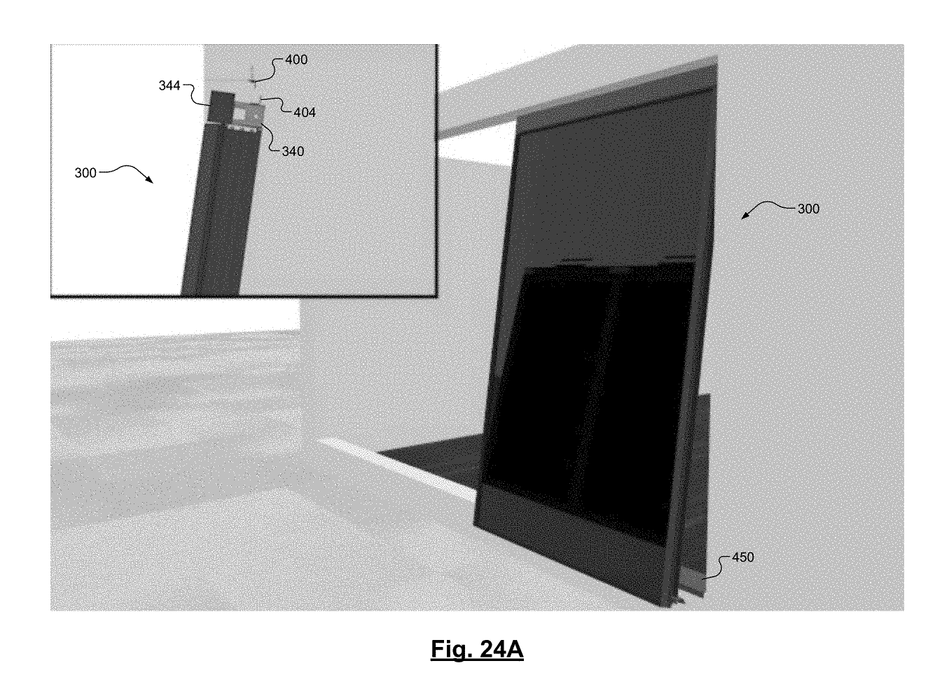

Referring now to FIGS. 22A-22B, techniques for mounting the frame assembly 304 within the opening 220 are described. In FIG. 21A, the mounting of an upper portion of the frame assembly 304 in an upper portion within the opening 220 with mounting hardware 400, 404, and 408 is illustrated. A top flange 400 can come pre-installed within the opening 220 (e.g., from a previous install or during construction or renovation of the structure 200) or can be delivered as part of the frame assembly 304 and installed within the opening 220. A header flange 404 can be delivered as part of the frame assembly 304 and can be fastened to the top flange using a fastener 408 to secure the frame assembly 304 within the opening 220. As shown, the insulation enclosure 344 is taller than the electrical enclosure 340 in order to hide the mounting hardware 400, 404, and 408 from view from outside of the modular window assembly 300.

In FIG. 22B, the mounting of a lower portion of the frame assembly 304 in a lower portion within the opening 220 with mounting hardware 450, 454, 458, and 462 is illustrated. A sill plate 450 can come pre-installed within the opening 220 (e.g., from a previous install or during construction or renovation of the structure 200) or can be delivered as part of the frame assembly 404 and installed within the opening 220. The installation of the sill plate 450 involves securing it directly within the opening 220 using fasteners. The sill plate 450 may define a water run-off or drainage ramp 454 (e.g., a 5 degree angle). The sill plate 450 further defines a locking fin 458 that fits in a recess 466 of the main structural frame 316. A push-on trim component 462 can optionally be installed atop the locking fin 458 to provide a more secure fit of the locking fin 458 within the recess 466. For example, the push-on trim component could be a plastic C-channel push-on trim piece.

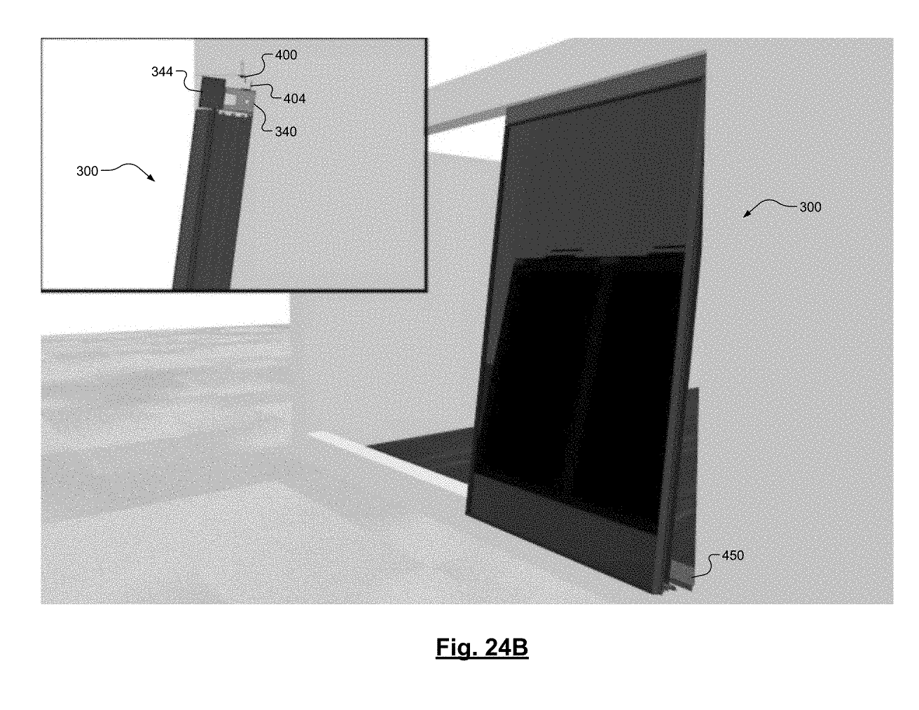

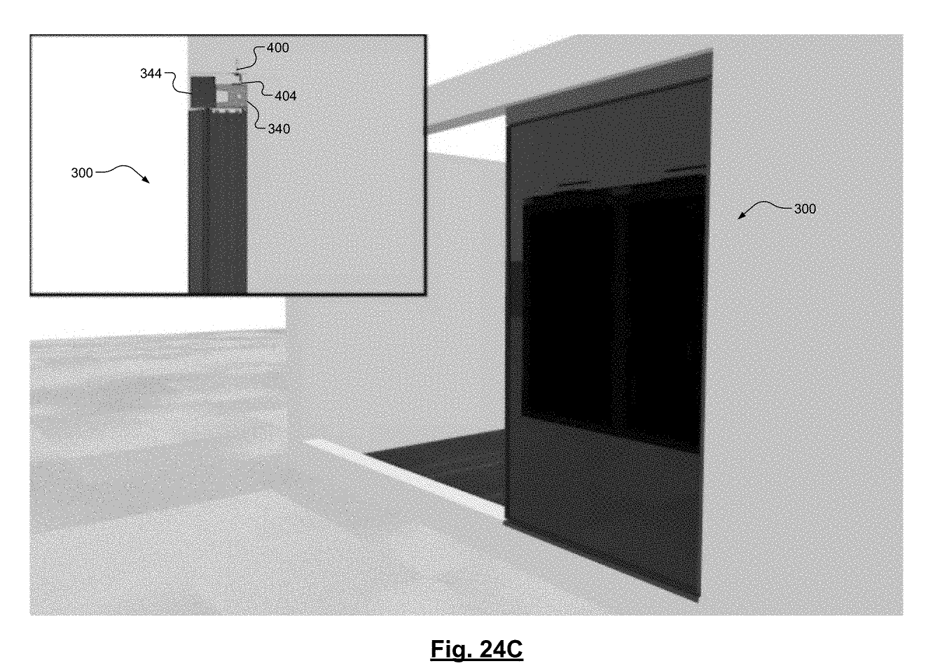

Referring now to FIG. 23, a flow diagram of an example method 500 for installing the modular window assembly 300 is illustrated. At 504, the sill plate 450 is installed in a lower portion of an opening. This can include aligning the sill plate 450 and then fixing the sill plate 450 to the lower portion of the opening 220, e.g., using one or more screws. At 508, the top flange 400 is installed in an upper portion of the opening. This can include aligning the top flange 400 and then fixing the top flange 400 to the upper portion of the opening 220, e.g., using one or more screws. As previously discussed, the top flange 400 could come pre-installed. It will also be appreciated that steps 504 and 508 could be performed in the opposite order. At 512, the modular window assembly 300 is tilted (see FIG. 24A) such that the top portion of the modular window assembly 300 is installed first. At 516, the top portion of the modular window assembly 300 is lifted into place (see FIG. 24B) such that the header flange 404 and the fixed top flange 400 are properly aligned with respect to each other.

At 520, the bottom portion of the modular window assembly 300 is slid into place (see FIG. 24C) such that the locking fin 458 and recess 462 are properly aligned. The fastener 408 between the top and header flanges 400, 404 could also be installed at this time. At 524, a sealant is optionally applied about an outer edge of the opening and the installed modular window assembly 300. At 528, the trim components 336, 348 are installed. At 532, at least one of the panes 308, 312 is removed by removing trim component 336 and corresponding fasteners, e.g., screws. At 536, at least one new pane is installed by aligning it with the empty portion of the carrier frame 332, reinstalling the corresponding fasteners (e.g., screws), and reinstalling the trim component 336. As discussed herein, it is very easy to swap out one or more of the glass panes 308, 312 over time and this process can be repeated.

What is claimed is:

1. A modular window assembly for an opening in a structure, the modular window assembly comprising:
a set of glass panes; and
a frame assembly mountable to the structure, the frame assembly comprising:
a main structural frame being mountable to the structure;
a removable exterior frame mountable to the main structural frame and defining an angled lip for water run-off, the removable exterior frame being configured to secure an outer glass pane of the set of glass panes;
an insulating feature disposed between the main structural frame and the removable exterior frame and configured to prevent thermal conduction therebetween; and
at least one vapor neutralizer between the main structural frame and the removable exterior frame and configured to prevent moisture from accumulating within the modular window assembly,
wherein the frame assembly is operable to receive any glass technology as developed.

2. The modular window assembly of claim 1, wherein the frame assembly further comprises a carrier frame mountable to the main structural frame and configured to position and secure one or more inner glass panes of the set of glass panes.

3. The modular window assembly of claim 2, wherein the carrier frame comprises one or more adjustable securing devices configured such that the one or more inner glass panes can be removed while the outer glass pane remains secured by the removable exterior frame.

4. The modular window assembly of claim 2, wherein the set of glass panes comprises the outer glass pane and two or more inner glass panes.

5. The modular window assembly of claim 4, wherein the outer glass pane is a monolithic glass pane and the two or more inner glass panes are part of an insulated glass (IG) assembly.

6. The modular window assembly of claim 5, wherein the IG assembly is a vacuum insulated glass (VIG) assembly, and further comprising an insulating cover over an interior portion of the frame assembly to improve the thermal performance of the frame assembly relative to the VIG assembly.

7. The modular window assembly of claim 2, wherein the at least one vapor neutralizer comprises (i) at least one dry seal disposed at an outer side of a cavity defined between the main structural frame and the removable exterior frame, (ii) at least one vapor barrier seal disposed at an inner side of the cavity, and (iii) at least one dust barrier seal disposed adjacent to or between the one or more inner panes.

8. The modular window assembly of claim 1, further comprising a trim component attachable to the frame assembly and configured to hide the frame assembly from view.

9. The modular window assembly of claim 1, further comprising an electrical system having at least one of power wiring running through the electrical enclosure and to an external power source and communication wiring.

10. The modular window assembly of claim 9, wherein the electrical system comprises at least one of a light system, a projection display system, a heating/ventilating/air conditioning (HVAC) system, an electrochromic system, and a dynamic shade system, a sensor system, an audio system, a noise cancellation system, wireless communication hubs, wireless communication repeaters, active collision avoidance systems, or other features as developed.

11. A frame assembly for a modular window assembly for an opening in a structure, the frame assembly comprising:
a main structural frame defining an electrical enclosure and being mountable to the structure;
a removable exterior frame mountable to the main structural frame and defining an angled lip for water run-off, the removable exterior frame being configured to secure an outer glass pane of a set of glass panes of the modular window assembly;
an insulating feature between the main structural frame and the removable exterior frame and configured to prevent thermal conduction therebetween; and
at least vapor neutralizer between the main structural frame and the removable exterior frame and configured to prevent moisture from accumulating within the modular window assembly.

12. The frame assembly of claim 11, further comprising a carrier frame mountable to the main structural frame and configured to position and secure one or more inner glass panes of the set of glass panes.

13. The frame assembly of claim 12, wherein the carrier frame comprises one or more adjustable securing devices configured such that the one or more inner glass panes can be removed while the outer glass pane remains secured by the removable exterior frame.

14. The frame assembly of claim 12, wherein the set of glass panes comprises the outer glass pane and two or more inner glass panes.

15. The frame assembly of claim 14, wherein the outer glass pane is a monolithic glass pane and the two or more inner glass panes are part of an insulated glass (IG) assembly.

16. The frame assembly of claim 15, wherein the IG assembly is a vacuum insulated glass (VIG) assembly, and further comprising an insulating cover over an interior portion of the frame assembly to improve the thermal performance of the frame assembly relative to the VIG assembly.

17. The frame assembly of claim 12, wherein the at least one seal comprises (i) at least one dry seal disposed at an outer side of a cavity defined between the main structural frame and the removable exterior frame, (ii) at least one vapor barrier seal disposed at an inner side of the cavity, and (iii) at least one dust barrier seal disposed adjacent to or between the one or more inner panes.

18. The frame assembly of claim 11, wherein the modular window assembly comprises a trim component attachable to the frame assembly and configured to hide the frame assembly from view.

19. The frame assembly of claim 11, wherein the modular window system comprises an electrical system having at least one of power wiring running through the electrical enclosure and to an external power source and communication wiring.

20. The frame assembly of claim 19, wherein the electrical system comprises at least one of a light system, a projection display system, a heating/ventilating/air conditioning (HVAC) system, an electrochromic system, and a dynamic shade system, a sensor system, an audio system, a noise cancellation system, and an active collision avoidance system, or other features as developed.
